(19) United States
(12) Patent Application Publication
(10) Pub. No.: US 2008/0007372 A1
(43) Pub. Date: Jan. 10, 2008

(54) System and method for preterminated network connection

(76) Inventor: James A. Carroll, Bloomington, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/821,010

(22) Filed: Jun. 21, 2007

Related U.S. Application Data
(60) Provisional application No. 60/815,370, filed on Jun. 21, 2006.

(51) Int. Cl. H01P 5/00

(52) U.S. Cl. 333/260

(57) ABSTRACT

A system of connecting computer and voice networks includes a plurality of voice or data cables with reusable connectors in manufacturing facility remote and combining them into a composite preterminated cable. A consolidation panel is located remote from a technology room and nearer to workstations than to the technology room. The consolidation panel includes a couplers adapted to receive the reusable connectors. Composite preterminated cables from a selection of the composite preterminated cables having fixed preselected lengths are used. A first composite preterminated cable is routed between the technology room and the consolidation panel. Excess cable length is stored somewhere between the technology room and the consolidation panel.

### CLAIM TO PRIORITY

This application claims the benefit of U.S. Provisional Patent Application 60/815,370, filed Jun. 21, 2006, which is incorporated herein in its entirety by reference.

### FIELD OF THE INVENTION

The invention generally relates to the field of network cabling for voice and data networks.

### BACKGROUND OF THE INVENTION

Since the early days of telephone systems, the cabling architecture used for premise building wiring was a zone type configuration. Before our modern cubical cities, buildings used an open floor and overlooking managerial office that was combined to allow managers to peer out and watch the staff work. The telephone was the first major communications device commonly distributed to the desktop. Because the facilities themselves hardly changed, cabling was installed using Telephone Terminal Cabinets (TTC's) which were tied back to a Main Distribution Frame (MDF) and associated key systems or patch facilities.

As common office communications grew to include fax machines and data lines (commonly used for computer dial up services), cabling that was once simplistic started to become more complex and difficult to manage. Furniture builders, no longer satisfied with providing desk units, began to produce cubical furniture for open office architecture that allowed for flexibility and a significant cost savings for space allocation. With the advent of Local Area Networks (LAN)/Wide Area Networks (WAN)-technology, came deployment of newer cabling technology such as Category-3 (CAT-3), Coaxial (RF) Distribution, Category-5/5e (CAT-5/5e), and Fire-wire. The cabling that extends from the MDF to the desktop, became of greater importance.

Communications infrastructure design has now essentially become an art form with as many as six different cables distributed to the desktop. Historically, most building designs, especially older buildings, such as schools and hospitals, did not provide adequate space for cable distribution. In recent years, it was thought that cables should be run directly from the MDF or equipment room to the desktop to reduce splicing and connection losses as cables are stressed to evolving faster network speeds. The Electronics Industry Alliance and Telecommunications Industry Association (EIA and TIA) began to address new requirements for campus premise cabling.

Due to ever-changing technology and the requirements of the cabling infrastructure, buildings now have more bulk weight from cables being run through their floors and ceilings than ever before. The lack of forethought given to cable distribution has made ceiling and floor plenum intertwined nightmares of cable infrastructure in many buildings. This, compounded with a plethora of moves, additions, and changes (MACs), has driven the cost of communications higher and higher.

Network cabling may be broken down into the following areas: main technology room (MTR); intermediate technology room (ITR); secondary ITR, zone cabling enclosures; backbone cabling; and station cabling.

The Main Technology Room (MTR) traditionally supports the file servers and implemented technologies. All backbone cables (copper and fiber) supporting voice and data technologies connect the MTR to multiple Intermediate Technology Rooms (ITR's). Occasionally, the MTR may support station cables (voice and data) installed within this room or returning to this room.

The intermediate technology room (ITR) traditionally supports star equipment technology (routers, hubs, and etc.), backbone cabling (copper and/or fiber), and voice and data station cabling for each workstation. Equipment and patch panels for data applications may be mounted onto racks. Voice equipment and voice applications traditionally may be mounted to the wall.

The consolidation point, secondary ITR, is where zone cabling solutions may be implemented, and consolidation points or secondary ITR may be incorporated into the design. Backbone cables (copper and fiber) may be installed in the ceiling riser shaft and connect the MTR to the ITR's. Data applications over copper wire generally have a total distance limitation of approximately 327 feet. This maximum distance includes the use of all patch cables. Typically all data applications on copper wire should be limited to a horizontal and vertical distance of 327 feet or 100 meters.

Voice applications over copper have fewer distance restrictions and can support distances of 2500 feet or greater. Optical fiber may be utilized for data application when distances exceed 100 meters. Fiber may be utilized for voice applications when the application requires it. Station workstation cables generally consist of at least one voice cable and at least one data cable.

In traditional cable installation, the station cable may be installed from the ITR or the MTR to each workstation location (furniture partition and or hard wall office), in a continuous run, i.e., without splices or breaks in the cable. The station cable may be pulled to length from 1000 feet cable spools, cut, and dressed to length. Each individual conductor may be terminated at the MTR or the ITR on a patch panel (data cable) or a station block (voice cable).

The station cable at the workstation side may either be dressed down a power pole and dressed into the wire management within the furniture partition or dressed up through a floor panel and into the wire management in the furniture partition. The station cables may be field terminated onto RJ45 female jacks and placed into a furniture partition faceplate.

Station locations in hard wall offices route the cable down the wall via pull string, conduit and box attached to the stud wall. Station cable conductors may be field terminated onto an RJ45 female jack or other generally recognized network connector with RJ45 being used as a representative only. The RJ45 female jack may then be placed into a faceplate and the faceplate screwed into the conduit box.

A disadvantage of this cable installation method is that all cable must be installed as a home run (continuous from the ITR to the station location). When furniture partitions are moved, existing cables need to be cut from the RJ45 female jacks, pulled back into the ceiling before the furniture partitions can be broken down and reconfigured. Occasionally, existing cables may be re-worked and re-used. If existing cables cannot be re-used, these cables, according to building code, must be removed from the ceiling.

The majority of station cables typically are abandoned and must be removed and discarded. New station cables must be installed from the ITR to the new station locations.

Sometimes these distances are 275 feet or greater. The cost a company incurs in the renovation may be at least threefold. First, there is the cost of labor to remove the abandoned cable. Second, there is the cost of wasting perfectly good cable that is just difficult to re-use. And third, there is the cost of labor and material to install new cable from the ITR to the new station location. Much of the cabling work must be completed after normal business hours, or on weekends, and paid at overtime rates, in an attempt to reduce employee down time resulting in delays and lost productivity in the work place.

When companies reconfigure their modular furniture, it is expensive to rewire the facility because of the limited flexibility of moving or re-using existing home run cables.

Existing zone cabling solutions provide for an additional termination and patching point in the cabling solution. The previous zone approach allowed for remote patching in at least one of the two areas: raised floor and/or ceiling.

A zone cable solution, which utilizes a raised floor method, requires the client to install consolidation points, that is, distribution boxes strategically placed throughout the facility underneath the raised floor. The raised floor may be 4 to 6 inches in height. The raised floor may be installed throughout the majority of the office facility. Modular furniture and offices may be installed on top of the raised floor. Station cable may be installed in large quantities from the MTR and/or the ITR to the consolidation point box enclosures. The consolidation point box enclosures may be a termination point (extension of the MTR and ITR patch panels out to the floor). The consolidation points ordinarily remain permanently fixed. Station cable may be installed from these consolidation point box enclosures to workstations. In some cases, a long patch cable (RJ45 male to RJ45 male patch cable) may be installed from the consolidation point distribution box to the workstation to support voice and data devices.

An alternative to patch cord connection may be a cable extension to the workstation where the cable may be terminated at the workstation end onto an RJ45 female jack. Patch cables may be extended from this female jack to communications devices.

Raised floor panels may be opened to accommodate future MAC's (moves, additions, and changes) in the cabling infrastructure. If a reconfiguration in furniture is required, only the station cable or patch cord from the consolidation point distribution box to the workstation may be necessary to be moved or replaced. This results in a cost savings because the company is only replacing or reconfiguring the last 50 feet of cable instead of the total run of 250 to 300 feet of station cable.

A disadvantage of raised floor zone cable solutions is the cost to install raised floors throughout a company's facility. Few companies can justify the expense or see a return on investment unless they own their own facility.

Another disadvantage is that the installation of zone cable from the MTR and/or the ITR to the consolidation point distribution box may be accomplished by setting up multiple 1000-foot spools of 4 pair cable. The cables may be pulled to length, cut, dressed into the zone distribution box and then dressed into the ITR. The cables may be dressed back to freestanding racks and into the patch panels. Each cable may be dressed to the termination point at the back of the patch panel at both ends of the cable. The cable may be stripped back and the pairs carefully separated, placed onto the back of the patch panel and terminated. Each individual conductor must be properly placed, terminated, and tested.

The most time consuming part of a cable installation is separation, placement, and termination of cable. Utilization of a zone distribution alternative at least doubles the number of station cable terminations resulting in additional trouble points, increasing field labor costs, and increases the cost of materials, the number of zone distribution boxes, patch panels, and patch cords, along with the associated labor to install these items.

Additionally, raised flooring tile may be difficult to access for MAC work. It may require the removal of carpet tiles (which may overlay floor tiles), furniture, filing cabinets, and modular furniture may also need to be moved to gain access where required. Finally, raised floor tiles typically require the removal of at least 4 screws that hold each tile to the base.

Another disadvantage is that terminations performed in the field are performed by numerous various installers, resulting in dissimilar connections, and leading to problems such as near end cross talk and signal impairment.

Ceiling zone distribution systems are configured and installed similar to a raised floor zone system. Multiple cable spools of 1000 feet may be set up and cable pulled to length, cut, and terminated in a ceiling consolidation point box enclosure. Station cable ports may be located throughout the ceiling and be available to support a given area within an office. The final fifty feet or so of station cable installation may be installed from the distribution panel to a workstation, down through a power pole, and into spaces provided in modular furniture, or up through a floor plenum and into the furniture partition. Once the cables are dressed into the furniture workstation, the cables may be terminated in each cubical onto an RJ45 female jack and tested.

The ceiling zone cabling solutions suffers some of the same disadvantages as the raised floor solution.

Another significant disadvantage of network cabling is that the cables come from the manufacturer without connective ends. Connective ends, such as the RJ45 connector are too large to fit through obstacles, conduits, face plates, etc. and the release clip on a RJ45 male connector gets caught on obstacles causing damage to the RJ45 male connector.

### SUMMARY OF THE INVENTION

The present invention includes preterminated cables to which sub-connectors are preterminated in a factory environment. The invention is described here in relation to unshielded twisted pair network cables but is equally applicable to shielded network cable solutions. In one aspect of the invention, the sub-connectors are small enough to fit through and past common obstacles encountered during a network wiring installation. The sub-connectors are adapted to establish operably communication to a corresponding connector of the type commonly used in the network wiring industry. The cables are provided with a sub-connector at each end thereof, in contrast to patch cables provided with standard RJ45 connectors, such as those removed from buildings during MAC's.

One aspect of the invention includes a factory installed wiring guide, or wiring cage sub-connector attached to cable ends to permit proper positioning of twisted pair conductors. The factory installed wiring guide provides quality termination and crimps to the cable that provides strain relief/support for the wires or fibers and the outer sheath of the cable.

The prefabricated cable and wiring guide sub-connector, in one embodiment of the invention, is sized to fit into small cable conduits and modular furniture electrical openings and raceways. The wiring guide is adapted to be insertable into a backside of an RJ45 female connector jack such as at a wall plate to complete termination of a station cable.

The prefabricated cable and wiring guide are connectable to the opposing side of an RJ45 female jack connector that permits the wiring guide of the cable to be inserted (installed) and removed (de-installed) a plurality of times into and out of the rear of, for example, an RJ45 connector. The wiring guide may be adapted to connect a cable to either a male or female RJ45 connector.

The connector of this invention facilitates the ability to pre-terminate and pre-test a category 3, 5E, 6 or 7 cables, or a group of composite or wrapped cables. Category 3, 5E, 6 and 7 cables are in use or expected to be used at the time of this application and are given as examples. The list should not be considered limiting. The pretermination and pretesting are accomplished in a manufacturing facility where quality can be readily controlled and automation can be utilized to terminate cables at a cost less than that of field termination.

A connector housing with installation cover is smaller than an 8 position RJ-45 or similar male connector. This permits preterminated cables in accordance with the invention to be easily pulled or otherwise directed through conduits or past obstacles to establish network connections. The connector housing shown is an example and other connector configurations can be used.

When there is no cover on the housing, the connector is positionable on the back side of an 8 position female jack, which, in one aspect of the invention, provides for an IDC (insulation displacement contact) like termination onto the backside of the jack. The IDC like termination includes the pressing of a blade contact into a forked contact member that establishes electrical and mechanical connection by the squeezing force of the forked contact member against the blade contact. As used in this application no insulation is present on the contact that needs to be displaced. It should be understood that IDC as used in this application includes connectors that press a contact into a mating forked contact whether insulation is displaced from the contact or not.

An example connector can be disconnected by pressing a release button and removing the connector, and can be re-connected many times without having to re-terminate or re-test the cable.

In one embodiment, an 8 position connector cover converts the connector into an 8 position male connector, allowing the connector to plug directly into a device having an RJ-45 or similar interface and eliminating the need for a female jack.

In one aspect of the invention, a wrapped or composite cable terminated by multiple connectors is utilized. Staggering the length of each individual cable within the wrapped or composite cable reduces the cross sectional area of the composite cable and allows the cable to be passed through conduits or furniture raceways in virtually the same space as bundles that are not terminated. In this way multiple preterminated cables can be placed at the same time increasing efficiency of installation.

In one aspect of the present invention, planning for the proper cable length is part of designing and implementing a pre-terminated network infrastructure. Pre-terminated cables require special extensions, so short cable lengths should be avoided. Furthermore, designing a cable or group of cables to exact length can be difficult. In another aspect of the invention, cables are designed long, and installation plans include a way to accommodate excess cable. For example, Excess cable length may be coiled in the ceiling space at the station end, near the access points. Excess cable length may also be coiled or looped as it is routed in the technology room.

Connectors terminate the individual cables of wrapped or composite cables. Wrapped or composite cables with two, four, six and eight individual cables may be utilized, but in accordance with the invention, the wrapped or composite cables can include other numbers of individual cables. Using a wrapped or composite cable can save significant field installation time. For example, a composite cable made up of 6 category 6 cables takes one sixth the time to label, pull, sort and dress than 6 individual category 6 cables.

Pre-terminating the cables is also less expensive and faster than terminating the cables in the field. Pre-terminating a connector requires less than two minutes in a factory fabrication process, but may require five to seven minutes or more in the field.

In one aspect of the invention, each voice composite cable may be dressed to its connection point and plugged in. This process may be repeated for each composite cable until some or all voice cables are connected.

An individual data composite cable is dressed to its connection point and the connector is slid into the back end of the 8 position female jack and the positioning guide is pushed down into locked position. Other connector configurations can, of course, be used.

A female jack is placed in the back of a patch panel. This process may be repeated until some or all of the data composite cables are connected and placed in the panel. Cables may be dressed through the furniture raceway to the furniture consolidation panel.

Excess cable may be left coiled in the ceiling near the access point. Excess cable may also be routed or installed in another appropriate manner.

At least two options may be employed, in accord with the invention, for installing connections in a furniture consolidation panel. In one option, the cable is extended with a dual IDC jack to a second consolidation panel. In another option, patch cords connect the furniture face plate to the furniture consolidation panel. A dual IDC connection coupler may be used for the first option. A dual IDC connection may be installed into the furniture consolidation panel, allowing for extension of the individual cables. Voice and data cables may be extended from the furniture consolidation panel to each workstation.

The extension is formed by running a composite furniture cable from the furniture consolidation panel (FCP) to each workstation. The composite furniture cable may be staggered at each workstation end.

Near the workstation, a connector is positioned and connected to each cable with an IDC-to-8 position jack and a furniture faceplate may be snapped into place.

An IDC-to-8 position jack may be used for the second option in which cables are routed to furniture consolidation panels. Each cable end is connected and placed in the furniture consolidation panel. This process may continue until some or all cables are connected and placed in the panel. The furniture consolidation panels in this configuration support four workstations each, but panels may support other numbers of cables. In this embodiment of the invention, station patch cords are installed from the furniture consolidation panel to each workstation.

Special patch cords in accordance with the invention, have a slip-off cover design to facilitate installation in the furniture raceway.

When changes in furniture layout or design are to be made, a jack lock release button is pushed, releasing the IDC connector, allowing the pre-terminated cable to be pulled back through the furniture raceway, up the access point and coiled in the ceiling. The workstations can then be broken down and moved into place in a new arrangement or location. Existing cable can be reinstalled.

An extension panel and extension cable can be installed if the pre-terminated cables are not long enough. Because each cable is pre-terminated and pre-tested, testing from the technology room to the workstation is optional.

The invention also includes the balancing of crosstalk between conductors within connectors, connector to connector coupler or connector to RJ coupler. Balancing may be accomplished by configuration of conductor paths within the component or by the use of a printed circuit board within or coupled to the component. Balancing crosstalk facilitates the use of a preterminated solution by improving signal quality beyond that achievable by the use of, for example, conventional RJ connectors and couplers.

The zone cabling system of the invention minimizes the up front costs to install a network zone cabling system. It also eliminates the need for field terminations which are the source of many of the performance and operation problems encountered in networks. The present invention results in more consistent high quality connection/termination of jacks at the workstation, the consolidation point distribution panel, the main technology room and the intermediate technology room.

The present invention reduces labor cost involved in the installation of zone cables by the use of multiple preterminated cable setups on spools that are predesigned to be longer than required to reach from the main technology room or the intermediate technology room to a consolidation point distribution panel. The zone cabling system, in one aspect of the invention requires no field termination and only the insertion of the wire guide and sub-connector combination into the back cavity of the RJ45 female connector or other coupler.

The cabling system of the present invention provides flexibility to quickly reconfigure an office or modular furniture area and reduces labor costs for future moves, additions and changes because only the last twenty five to seventy five feet of station cable has to be reconfigured.

The cabling system of the invention allows for testing of preterminated cables at the manufacturer in the factory instead of or in addition to field testing. This results in time saved over field certification. The present invention fulfills these and other needs, and addresses other deficiencies of prior art implementations.

### BRIEF DESCRIPTION OF THE DRAWINGS

FIG. 1 is a perspective view of a network connector in accordance with the invention with a pulling cover attached.

FIG. 2 is a perspective view of several example pre-terminated composite cables in accordance with the invention.

FIG. 3 is another perspective view of the network connector with pulling cover depicted in FIG. 1.

FIG. 4 is a perspective view of an example network connector with the protective cover removed.

FIG. 5 is a perspective view of an example network connector connected to a network connector to RJ coupler.

FIG. 6a is a perspective view of an example network connector with an RJ connector/adaptor attached thereto.

FIG. 6b is a perspective view of the connector with RJ adaptor cover of FIG. 6a inserted into an ethernet port.

FIG. 7a is a perspective view of a pre-terminated composite data cable depicting a staggered connector arrangement.

FIG. 7b is a perspective view comparing staggered pre-terminated connectors with conventional unstaggered connectors.

FIG. 8 is a perspective view of excess cable length coiled in a ceiling space in accordance with the invention.

FIG. 9 is a perspective view of voice network cables showing an alternative embodiment of storing excess length.

FIG. 10 is a perspective view of technology room equipment showing another embodiment of storage of excess cable length.

FIG. 11 is a perspective view of several composite data cables in accordance with the invention.

FIG. 12 is a perspective view of an example network connector being coupled to an example wall jack.

FIG. 13 is a perspective view showing a completed connection depicted in FIG. 12.

FIG. 14 is a perspective view of a coupled network connector and network connector jack being inserted into a supporting panel in accordance with the invention.

FIG. 15 is a perspective view of excess cable length being stored in a ceiling and cable being routed down to an access point.

FIG. 16a is a perspective view of a network connector to connector jack or coupler in accordance with the invention.

FIG. 16b is a perspective view of the coupler of FIG. 16A placed in a consolidation panel with cables attached thereto in accordance with the invention.

FIG. 16c is a perspective view of a plurality of voice and data network connections utilizing the connector coupler depicted in FIG. 16A.

FIG. 16d is a perspective view of a furniture consolidation panel in accordance with the invention.

FIG. 17 is a schematic plan view depicting a furniture consolidation panel and a composite furniture cable in accordance with the invention.

FIG. 18a is a perspective view of a wall jack and cover panel supporting voice and data network connector to RJ connector couplers in accordance with the invention.

FIG. 18b is a perspective view of an assembled wall plate as depicted in FIG. 18a.

FIG. 19 is a perspective view of a network connector to RJ style jack in accordance with the invention.

FIG. 20a is a schematic plan view of the location of furniture consolidation panels in accordance with the invention.

FIG. 20b is a perspective view showing the coupling of a network connector with a coupler in accordance with the invention.

FIG. 21 is a perspective view of a furniture consolidation panel depicting a plurality of voice and data network cables in accordance with the invention.

FIG. 22 is a schematic plan view depicting the connection of furniture consolidation panels to workstations in one embodiment of the invention.

FIG. 23a depicts a special protective cover for a patch cable in accordance with the invention.

FIG. 23b depicts the patch cable connector of FIG. 23a with the protective cover removed.

FIG. 24a is a perspective view of a patch cable in accordance with the invention being connected to a coupler.

FIG. 24b is a schematic perspective view depicting cable being removed and stored in a ceiling in preparation for a move, addition, or change.

FIG. 25a is a phantom perspective view of an extension panel in accordance with the invention.

FIG. 25e is a perspective view of a completed move, addition, or change in accordance with the invention.

FIG. 26 is a non-exclusive list of benefits in accordance with the invention.

FIG. 27 is another perspective view of an example network connector and jack in accordance with the invention.

FIG. 28 is a perspective view of a spool of data cable in accordance with the invention depicting labeling.

FIG. 29 is a perspective view of RJ-21 amphenol connectors that can be utilized with voice network cables in accordance with the invention.

FIG. 30 is a perspective view of a spooled composite voice cable in accordance with the invention depicting an RJ-21 amphenol connector and staggered individual cable connectors.

FIG. 31 is a schematic perspective view of a cable pulling operation in accordance with the invention.

FIG. 32 is a perspective view of network cable that has been pulled and stored in a ceiling space in accordance with the invention.

FIG. 33 is a schematic perspective view of a technology room and multiple pulled composite cables in accordance with the invention.

FIG. 34 is a perspective view of the coupling of RJ-21 amphenol connectors for voice cables in accordance with the invention.

FIG. 35 is a perspective view of the end of a composite cable showing eight individual pre-terminated cables in accordance with the invention.

FIG. 36 is a perspective view of the insertion of a network coupler and example network connector into a panel in accordance with the invention.

FIG. 37 is a perspective view of installers dropping cables from the ceiling in accordance with the invention.

FIG. 38 is a perspective schematic phantom view of cabling and a furniture consolidation panel in accordance with the invention.

FIG. 39 is a schematic plan view of a furniture consolidation panel and composite furniture cables in accordance with the invention.

FIG. 40 is a perspective view of an installed wall plate, including voice and data jacks in accordance with the invention.

FIG. 41 is a perspective view of an RJ style connector, a connector to RJ style coupler, and an example pre-terminated network cable connector in accordance with the invention.

FIG. 42 is a schematic plan view of a network arrangement in accordance with the invention.

FIG. 43 is a schematic perspective view of a network installation environment in accordance with the invention.

FIG. 44 is a schematic perspective view of a composite cable being pulled to a ceiling consolidation cabinet from a technology room in accordance with the invention.

FIG. 45 is a schematic perspective view of a first composite cable from a technology room to a ceiling consolidation panel, and a second composite cable from the ceiling consolidation cabinet to a workstation cluster.

FIG. 46 is a schematic perspective view depicting the second composite cable coiled for storage until further construction is completed.

FIG. 47 is a perspective view of stored cable in a ceiling space including composite cable in a conduit.

FIG. 48 is a perspective view of a ceiling consolidation cabinet or panel in accordance with the invention.

FIG. 49 is a perspective view of the ceiling consolidation cabinet including partially installed composite cables in accordance with the invention.

FIG. 50 is a detailed perspective view of the ceiling consolidation cabinet of FIG. 49.

FIG. 51 is a perspective view of a ceiling consolidation cabinet including a plurality of installed voice and data cables and a plurality of network couplers in accordance with the invention.

FIG. 52 is a schematic plan view of a ceiling consolidation panel, a composite furniture cable, and other routed cables in accordance with the invention.

FIG. 53 is a schematic plan view of another embodiment of a ceiling consolidation panel and furniture consolidation panel in accordance with the invention.

FIG. 54 is a perspective view of the installation of a coupling jack into a furniture consolidation panel in accordance with the invention.

FIG. 55 is a perspective view of an example network connector to network connector coupler jack in accordance with the invention.

FIG. 56 is a perspective phantom view of a plurality of couplers and station cables installed in a consolidation panel in accordance with the invention.

FIG. 57 is a perspective view of installed jumper cables in accordance with the invention.

FIG. 58 is a perspective view of a completed jumper cable installation in accordance with the invention.

FIG. 59 is a block diagram of a network structure in accordance with an embodiment of the invention.

FIG. 60 is another block diagram of a network structure in accordance with an embodiment of the invention.

FIG. 61 is a block diagram of another network structure with accordance with an embodiment of the invention.

FIG. 62 is a block diagram of a network structure in accordance with another embodiment of the invention, depicting two alternative options.

### DETAILED DESCRIPTION

The invention relates to low voltage zone cabling through the use of a pre-terminated zone cables that provide all the advantages of traditional and existing zone cabling methods while minimizing or eliminating the disadvantages of traditional or existing zone cabling methods.

### Overview

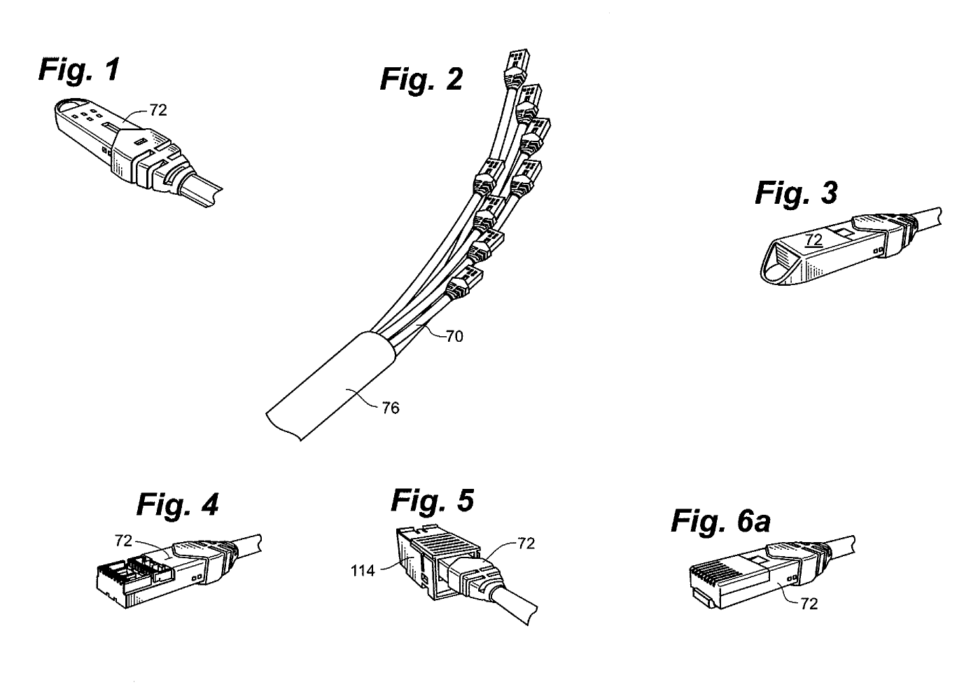

Referring to FIGS. 1 and 2, the industry standard connector of this invention provides for the ability to pre-terminate and pre-test a category 3, 5E, or 6 cable, or a group of composite or wrapped cables. The pretermination and pretesting are accomplished in a manufacturing facility where quality can be readily controlled and automation can be utilized to terminate cables at a cost less than that of field termination.

Referring to FIG. 3, the connector housing with the installation cover is smaller than an 8 position RJ-45 or similar male connector. This permits the preterminated cables to be easily pulled or otherwise directed through conduits or past obstacles to establish network connections. The connector housing shown is an example and other connector configurations can be used.

Referring to FIG. 4, when there is no cover on the housing, the connector is positionable on the back side of an 8 position female jack, which provides for an IDC like termination onto the backside of the jack.

Referring to FIG. 5, the completed connection to this jack is depicted. The connector can be disconnected by pressing a release button and removing the connector, and can be re-connected many times without having to re-terminate or re-test the cable.

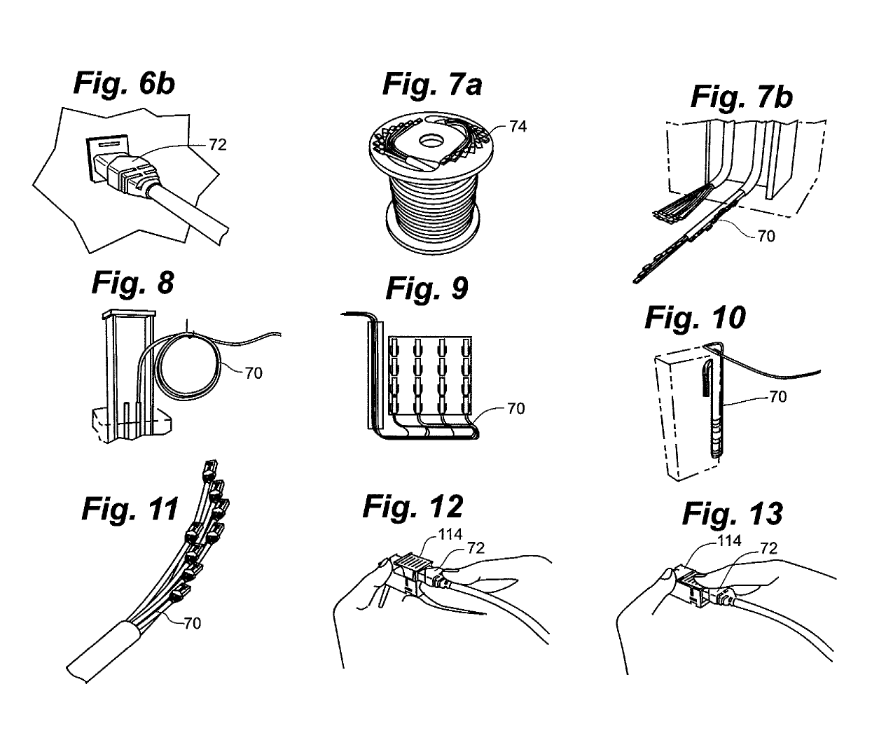

Referring to FIGS. 6a and 6b, an 8 position connector cover converts the connector into an 8 position male connector, allowing the connector to plug directly into a device having an RJ-45 or similar interface and eliminating the need for the female jack.

Referring to FIGS. 7a and 7b, a wrapped or composite cable terminated by a connector is shown. Staggering the length of each individual cable within the wrapped or composite cable allows the cable to be passed through conduits or furniture raceways in virtually the same space as bundles that are not terminated. In this way multiple preterminated cables can be placed at the same time increasing efficiency of installation.

In one aspect of the invention, planning for the proper cable length is part of designing and implementing a pre-terminated network infrastructure. Pre-terminated cables require special extensions, so short cable lengths should be avoided. Furthermore, designing a cable or group of cables to exact length can be difficult. In another aspect of the invention, cables are designed long, and installation plans include a way to accommodate the excess cable.

For example, referring to FIG. 8, excess cable length may be coiled in the ceiling space at the station end, near the access points.

Referring to FIGS. 9 and 10, excess cable length may be coiled or looped as it is routed in the technology room as depicted.

Referring to FIG. 11, the connectors terminate the individual cables of wrapped or composite cables. Wrapped or composite cables with two, four, six and eight individual cables are shown, but in accordance with the invention, the wrapped or composite cables can include other numbers of individual cables. Using a wrapped or composite cable can save significant field installation time. For example, a composite cable made up of 6 category 6 cables takes one sixth the time to label, pull, sort and dress than 6 individual category 6 cables.

Pre-terminating the cables is also less expensive and faster than terminating the cables in the field. Pre-terminating a connector requires less than two minutes in a factory fabrication process, but may require five to seven minutes or more in the field.

In one aspect of the invention, each voice composite cable may be dressed to its connection point and plugged in. This process may be repeated for each composite cable until some or all voice cables are connected.

Referring to FIG. 12, an individual data composite cable is dressed to its connection point and the connector is slid into the back end of the 8 position female jack mate and the positioning guide is pushed down into locked position. Other connector configurations can, of course, be used.

Referring to FIG. 13, a completed IDC like connection of the jack is shown.

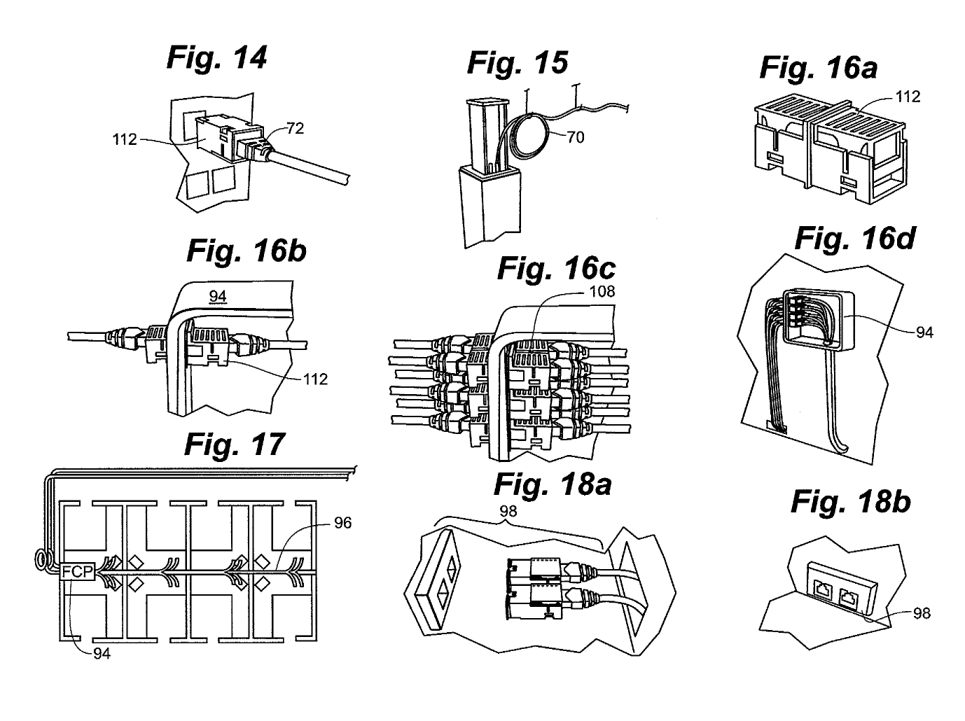

Referring to FIG. 14, the female jack is placed in the back of the patch panel. This process may be repeated until some or all of the data composite cables are connected and placed in the panel. Cables may be dressed through the furniture raceway to the furniture consolidation panel.

Referring to FIG. 15, any excess cable may be left coiled in the ceiling near the access point. Excess cable may also be routed as depicted in FIGS. 9 and 10, or installed in another appropriate manner.

At least two options may be employed, in accord with the invention, for installing connections in a furniture consolidation panel. In one option, the cable is extended with a dual IDC jack to a second consolidation panel. In another option, patch cords connect the furniture face plate to the furniture consolidation panel.

Referring to FIG. 16a, the dual IDC connection coupler used for the first option is shown.

Referring to FIG. 16b, a dual IDC connection may be installed into the furniture consolidation panel, allowing for extension of the individual cables.

Referring to FIGS. 16c and 16d, voice and data cables are extended from the furniture consolidation panel to each workstation.

Referring to FIG. 17, the extension is formed by running a composite furniture cable from the furniture consolidation panel (FCP) to each workstation. The composite furniture cable may be staggered at each workstation end as shown.

Referring to FIGS. 18a and 18b, the connector is positioned and connected to each cable with an IDC-to-8 position jack and a furniture faceplate may be snapped into place.

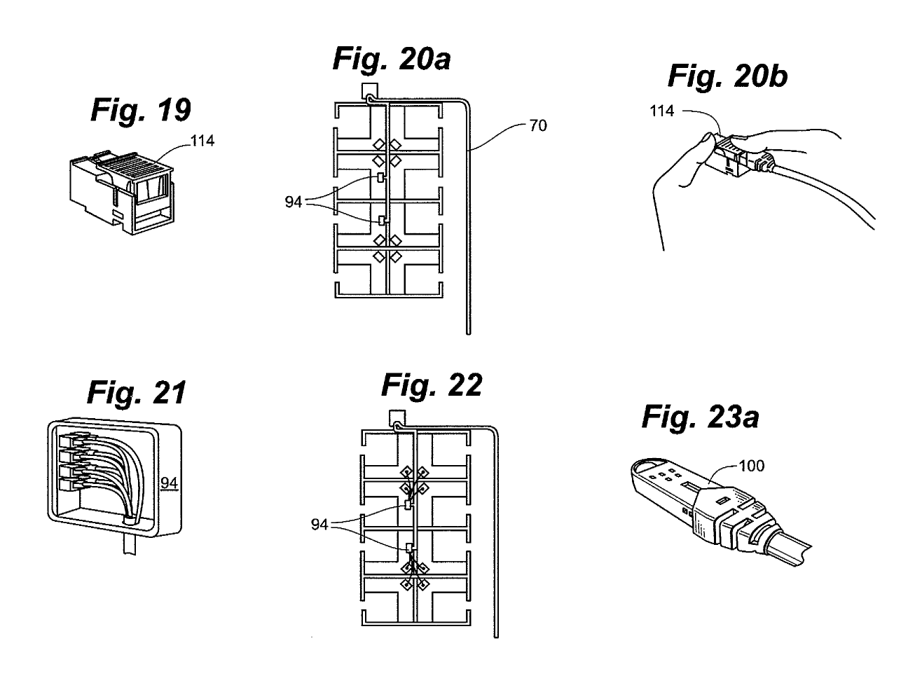

Referring to FIG. 19, an IDC-to-8 position jack used for the second option is shown.

Referring to FIG. 20a, cables are routed to furniture consolidation panels.

Referring to FIG. 20b, the IDC-to-8 position jack is installed on the end of an individual cable.

Referring to FIG. 21, each cable end is connected and placed in the furniture consolidation panel. This process may continue until some or all cables are connected and placed in the panel. The furniture consolidation panels in this configuration support four workstations each, but panels may support other numbers of cables.

Referring to FIG. 22, station patch cords are installed from the furniture consolidation panel to each workstation.

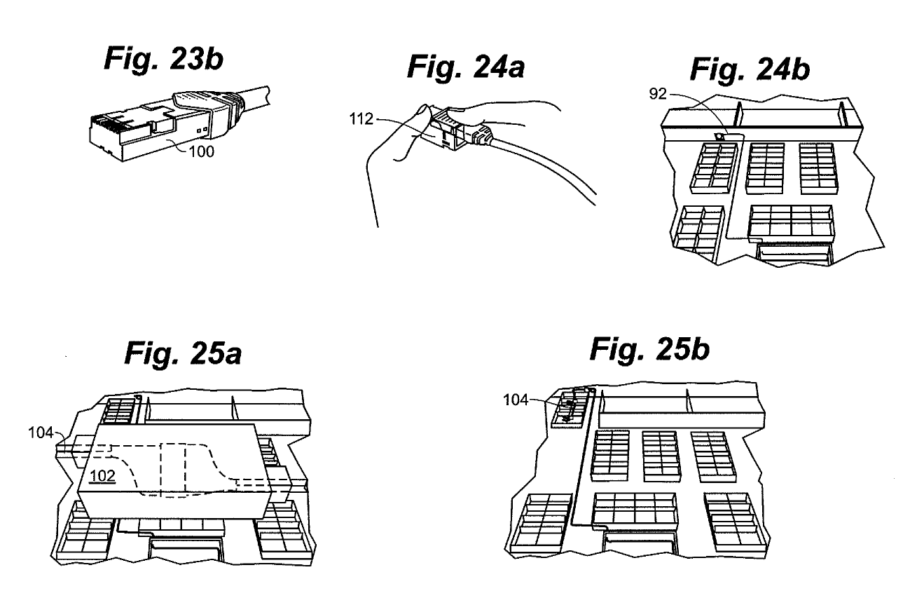

Referring to FIGS. 23a and 23b, these special patch cords have a slip-off cover design to facilitate installation in the furniture raceway.

Referring to FIGS. 24a and 24b, when changes in furniture layout or design are about to be made, the jack lock release button is pushed, releasing the IDC connector, allowing the pre-terminated cable to be pulled back through the furniture raceway, up the access point and coiled in the ceiling. The workstations can then be broken down and moved into place in a new arrangement or location. Existing cable can be reinstalled.

Referring to FIGS. 25a and 25b, an extension panel and extension cable can be installed if the pre-terminated cables are not long enough. Because each cable is pre-terminated and pre-tested, testing from the technology room to the workstation is optional.

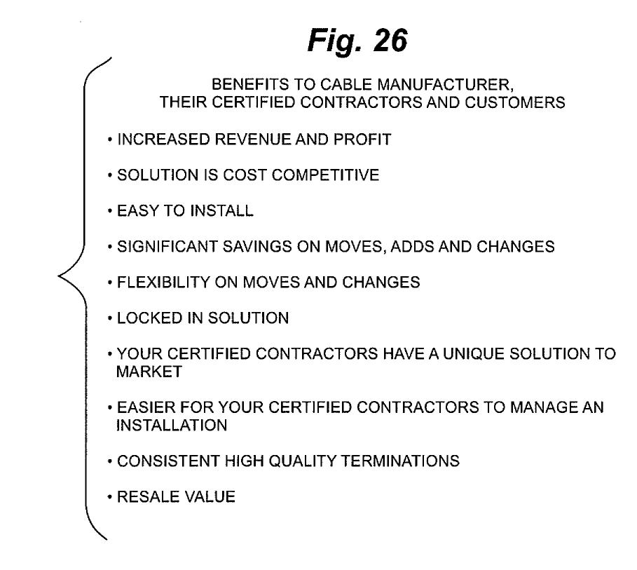

Referring to FIG. 26, a non-exclusive list of benefits to the cable manufacturer, their certified contractors and customers is shown. Manufacturers can sell a value-added solution to their customers. Cable sold by the spool is just a commodity. The pre-terminated, pre-tested system of the invention is a plug and play solution that adds value to cable products. This results in increased revenue and increased profit.

### Detailed Implementation

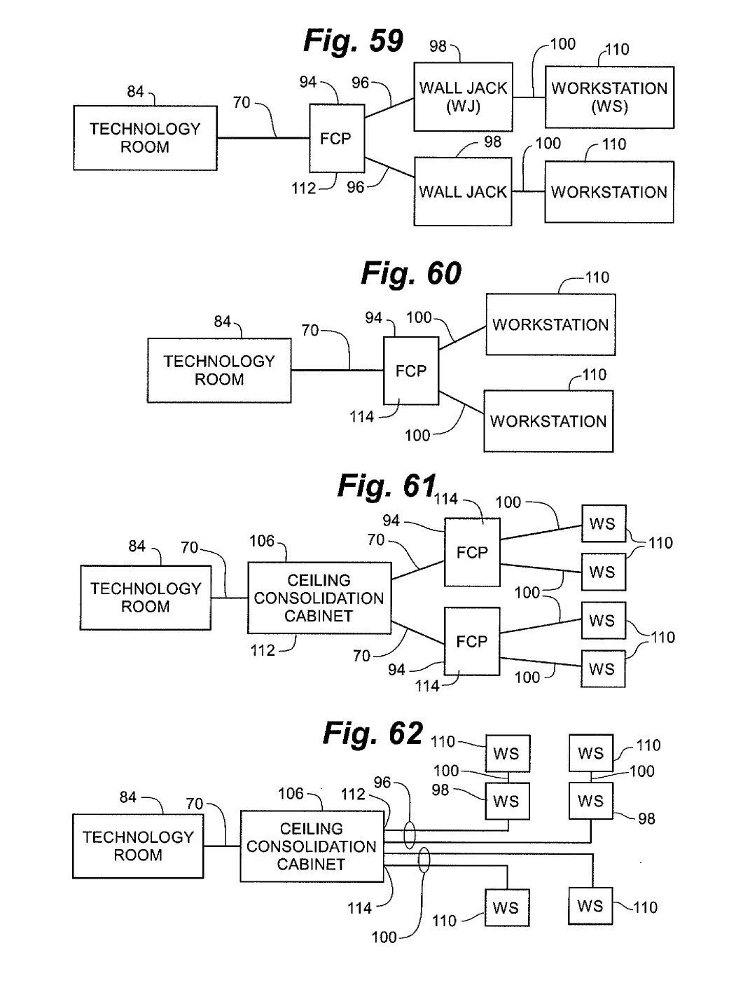

Referring to FIG. 59, as schematically depicted, one embodiment the invention includes technology room 84, composite cable 70, furniture consolidation panel 94, composite furniture cable 96, wall jack 98, patch cord 100, and workstations 110. Technology room 84 is communicatively coupled to furniture consolidation panel by composite cable 70. Composite cable 70 includes, for example, 2, 4, 6, or 8 voice or data cables 78, 76 bundled together and secured so that at least one end of the cables is terminated by individual male connectors 72. The position of connectors 72 may be staggered to reduce the cross sectional area of the end of composite cable 70 to facilitate the passage of composite cable 70 through conduits and past obstacles encountered in the routing of composite cable 70 between technology room 84 and furniture consolidation panel 94.

Furniture consolidation panel 94 includes an enclosure and internal supports for connector to connector couplers 112.

Furniture consolidation panel 94 is communicatively coupled to wall jack 98 by composite furniture cable 96. Composite furniture cable 96 includes a plurality of staggered length, data cables 76 or voice cables 78. Composite furniture cable 96 includes pre-terminated similar connectors 72 on each end of each included data cable 76 or voice cable 78.

Wall jack 98 couples connectors 72 to an eight position connector such as a conventional RJ45 male connector. In one aspect of the invention, wall jack 98 includes back-to-back female connectors, one for the connector utilized with data cables 76 or voice cables 78 according to the invention and the other for a conventional RJ style connector.

Wall jack is coupled to workstation 110 by patch cord 100. Patch cord 100 may include a conventional RJ to RJ patch cord for transmitting voice or data. Referring to FIG. 60, another embodiment of the invention is depicted in schematic form. This embodiment includes technology room 84, composite cable 70, furniture consolidation panel 94, patch cord 100, and workstations 110.

Technology room 84 is communicatively coupled to furniture consolidation panel 94 by composite cable 70 similar to that discussed above. In this embodiment, furniture consolidation panel 94 supports female to female connector to RJ coupler 114. Furniture consolidation panel 94 is communicatively coupled to workstations 110 by patch cords 100. In this embodiment of the invention patch cords 100 may be conventional RJ to RJ patch cords.

Referring to FIG. 61, another embodiment of the invention is depicted in schematic form. This embodiment includes technology room 84, composite cable 70, consolidation cabinet 106, second composite cable 70, furniture consolidation panels 94, patch cord 100, and workstations 110. In this embodiment technology room 84 is communicatively coupled to consolidation cabinet 106 by first composite cable 70. Consolidation cabinet 106 is typically positioned at the ceiling at a location remote from technology room 84 and intermediate technology room 84 and workstations 110. Generally, consolidation cabinet 106 is located nearer to workstations 110 to than to technology room 84. In one aspect of the invention, consolidation cabinet 106 includes a large number of supports for connector to connector couplers 112. Consolidation cabinet 106 is also adapted to support connector to RJ couplers 114.

Consolidation cabinet 106 is communicatively coupled to furniture consolidation panels 94 by second composite cable 70.

In this embodiment of the invention, furniture consolidation panel 94 supports a plurality of female-female connector to RJ couplers 114. Furniture consolidation panel 94 is communicatively coupled to workstation 110 by patch cord 100. In this embodiment of the invention, patch cord 100 is a conventional RJ TO RJ patch cord.

Referring to FIG. 62, another embodiment of the invention is depicted in schematic form. This embodiment includes technology room 84, composite cables 70, consolidation cabinets 106, composite furniture cables 96, wall jacks 98, patch cords 100, and workstations 110. In this embodiment, technology room 94 is connected to consolidation cabinet 106 by composite cable similar to above. In a first aspect of the invention, consolidation cabinet 106 supports a plurality of connector to connector couplers 112 as described above.

Consolidation cabinet 106 is coupled to wall jacks 98 by composite furniture cable 96 as described above. Wall jacks include a connector to RJ coupler 114, female to female jack. Wall jacks 98 are communicatively coupled to workstations 110 by conventional RJ to RJ patch cord 100. In an alternate embodiment of the invention, consolidation cabinet 106 supports a plurality of connector to RJ jacks 114. Consolidation cabinet 106 is then coupled to workstations 110 by conventional RJ to RJ patch cables 100.

Planning is an important element in designing and implementing a pre-terminated network in accordance with the invention. Designing a network in accordance with the invention involves the capture of certain information and the incorporation of this information on blueprints or plans. Information gathered in relation to the present invention includes the location of a technology room, work stations, cable runs, access points and cable distances.

In utilizing pre-terminated cables in accordance with the present invention it is important that cable lengths not be short relative to the needs to the installation. One aspect of the present invention includes designing a cable or group of cables to have excess length and installing the excess cable length at a location to accommodate its storage. For example, generally a minimum of 10 percent cable access length is added to each cable run to ensure adequate cable length. An excess length of 10 percent approximates the amount of waste experience in a traditional network cable installation. In one aspect of the present invention, excess cable length is coiled in the ceiling near a work station near the access points. Further, excess cable length may be stored in or near the technology room.

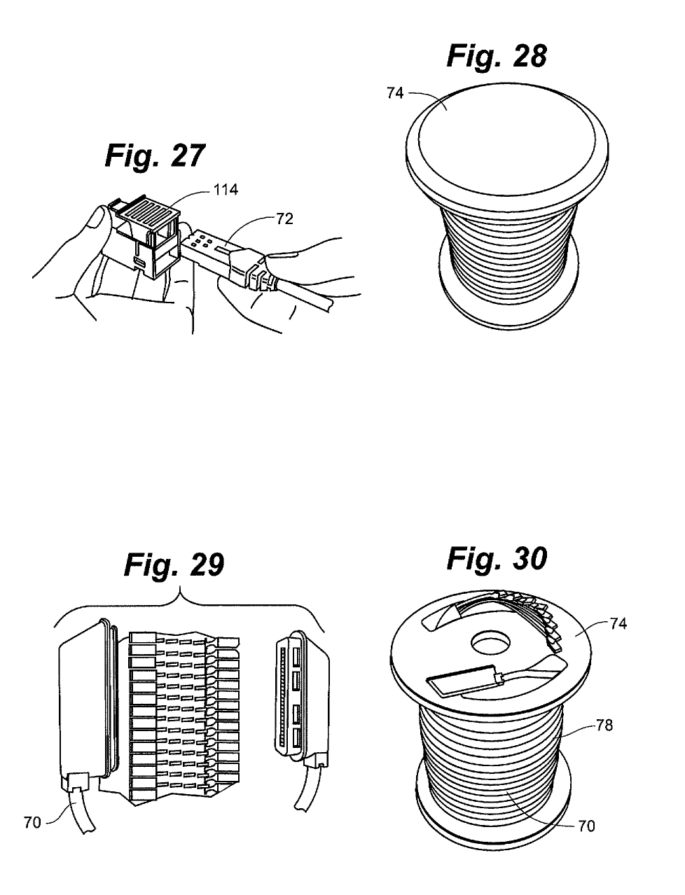

Referring to FIGS. 27-35, in one aspect of the present invention, a composite cable 70, is utilized. Composite cable 70 includes, for example, 2, 4, 6 or 8 cables, that are terminated at both ends with cable connectors 72. The composite cable 70 is cut to length and terminated with connector 72 on each end in a manufacturing facility remote from the installation location. Composite cable 70 may be made in preselected lengths, for example in lengths of twenty five, fifty, seventy five and one hundred meters. Composite cable 70 may conveniently be provided on spool 74. In one embodiment of the invention data cable 76 utilizes a connector at each end of the cable which provides for an insulation displacement contact (IDC) termination, for example, into the back side of an eight position female jack such as an RJ45 female jack. Example connectors are described in U.S. Pat. Nos. 7,229,309, 7,017,267, 7,014,495, 7,163,416 and U.S. patent application Ser. No. 11/639/729, the Detailed Descriptions, Summaries and Figures of which are incorporated by reference herein, as well as connectors compatible with IEC standard 60603-7-7 © IEC:2006(E) which is incorporated by reference herein. Other example connectors usable in the context of the invention include the GG45 and GP45 developed by Bel Stewart in cooperation with Nexans. Each preterminated cable included in composite cable 70 may be staggered to allow easy passage through conduits, down power poles, and through access points that are required to install the cable as it extends from a technology room to a work station or other location.

Example composite cables 70 and spools 74 are depicted in FIGS. 28 and 30. Voice cable 78 may utilize a connector 72 at the workstation end similar to that described above with relation to data cables 76. This connector may include an IDC termination adapted to be coupled into the back side of an 8 position female jack, such as an RJ45 or other RJ jack.

Referring particularly to FIG. 29, the technology room end of voice cable 78 may include an RJ21 amphenol connector. Each termination of the voice cable at the workstation end of the composite cable 70 is staggered to allow easy passage of voice cable 78 through conduits, down power poles and past access points.

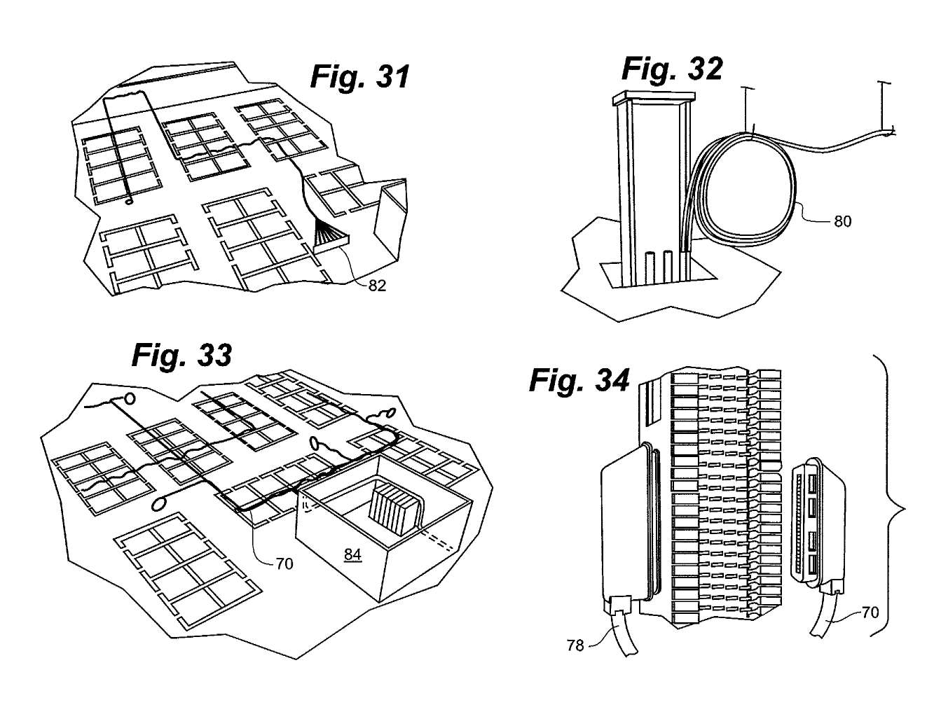

The term “station cable 80” encompasses both data cables 76 and voice cables 78. The installation of station cables 80 begins early in the construction process. Referring particularly to FIG. 31, cable stands 82 are placed either inside of, or near to, technology room 84. Multiple composite cable spools 74, including pre-manufactured length, 4 pair of category 5e or category 6 data cable 76 and 4 additional pair of category 3 voice cables 78 are included. These cable designations are commonly used at the time of this application and are used as example but should not be considered limiting.

Each spool 74 is labeled with the station locations number where the group of cables on the spool 74 are to be installed. Each station cable 80 is labeled as well as is depicted in FIGS. 28 and 30. Referring to FIGS. 32 and 33 voice cables 78 and data cables 76 are pulled through the ceiling, walls, floors or conduits and routed to appropriate access points as designated on the plans. Generally during the routing phase of network construction, furniture, work stations and access points have not been installed. At the end of the station cable 80, distant from the technology room, excess cable length is coiled and hung in the ceiling close to the planned location of an access point. The stored station cables 80 will be installed later when access points and furniture are in place.

All cable is spooled off the spool 74 leaving a sufficient length of cable at the end near technology room 84 to reach the connection points within the technology room 84. Each composite cables 70 is labeled and coiled in the ceiling near the technology room. In one aspect of the invention, because each composite cables 70 is terminated to length each cable pull requires a new cable set-up. The process of pulling the composite cable 70 continues until all the cables are roughed in. Since each composite cable 70 includes 2, 4, 6, 8 or more cables, the pulling process is significantly reduced.

In one aspect of the invention, during construction priority is given to completion of the technology room 84 walls and floor so that cable installation can continue. Referring to FIGS. 33, for example, ladder racks, free standing racks and/or wall mount racks may be installed in the technology room 84. Voice cables 78 and data cables 76 are separated from one another near the technology room. The existence of composite cable 70 facilitates the separation of the cables as opposed to the use of individual cables. Composite cables 70 are fed into technology room 84 and dressed to their area of connection.

Next, the composite cables are separated and placed in sequential order. As depicted in FIG. 34, each voice composite cable is dressed to its connection point and plugged in. This process is repeated until each voice cable is connected.

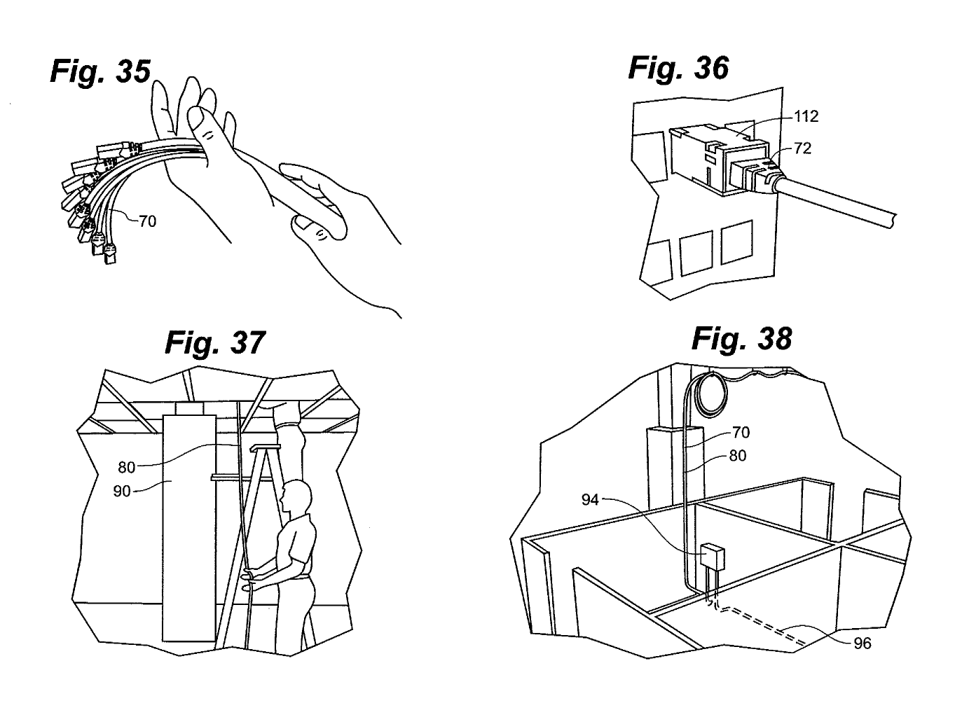

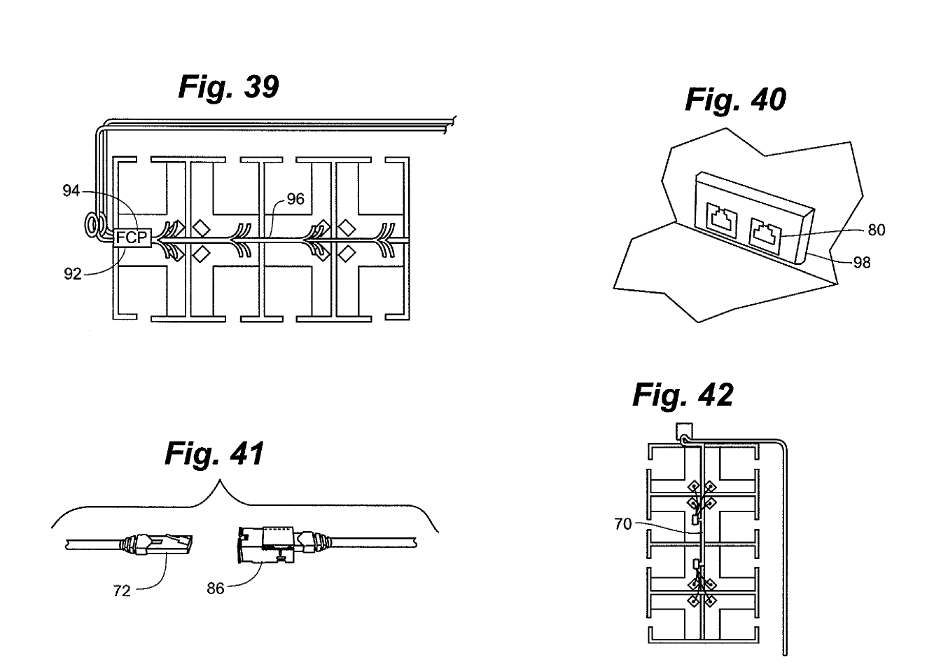

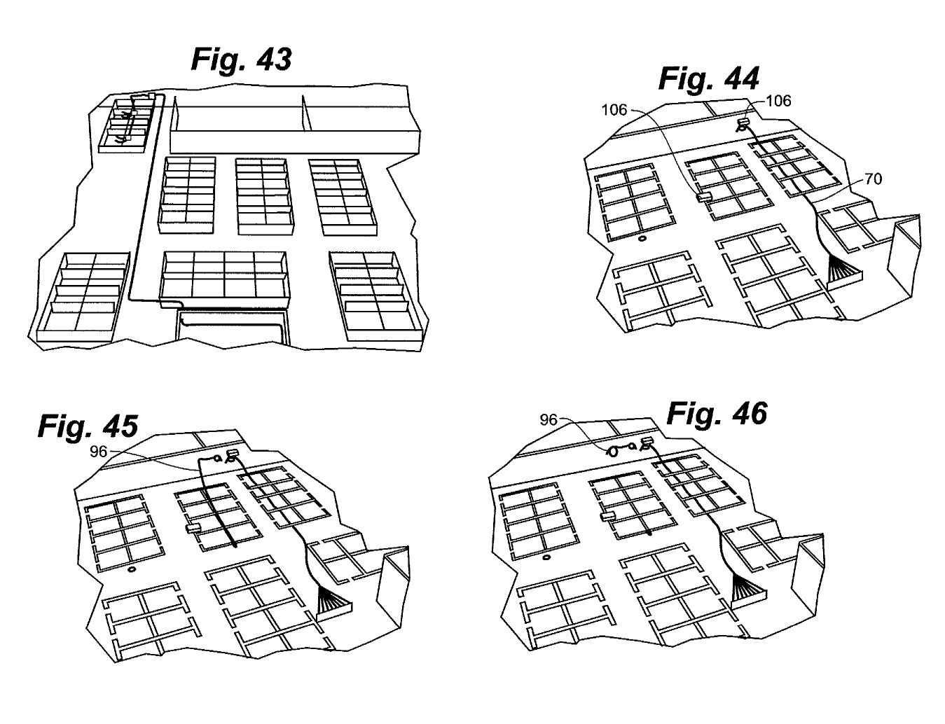

Referring to FIGS. 35 and 36, each data cable 76 is separated and placed in sequential order. Pre-terminated connectors 72 at the end of each data cable 76 are coupled to an eight position female jack 86 and secured in position.

The eight position female jack 86 is placed in patch panel 88. This is repeated until all data cables 76 are connected and placed in patch panel 88. While this work is being done in the technology room, construction on the rest of the floor may be continuing. Near the end of construction ceiling grids, ceiling tile and carpet are installed. Furniture, power poles and access points are put into place. Once the furniture, power poles and access points are located the process of completing station cable 80 can proceed.

As depicted in FIGS. 37 and 38, station cables 80 are released from the ceiling, dropped to the floor, and uncoiled. Station cable 80 ends are lifted to the top of power poles 90 and dressed down through and out the bottom at access points 92. In one embodiment of the invention, station cables 80 are then dressed through a furniture raceway to furniture consolidation panel 94. Any excess cable length may be left coiled in the ceiling.

Another embodiment of the present invention includes a composite furniture cable 96. Composite furniture cable 96 includes a number of cables having lengths staggered, for example, every eight feet. As depicted in FIG. 9, a proximal end of composite furniture cable 96 connects to a female connector at furniture consolidation panel 94, and extends to a number of work stations where it may be coupled to wall jacks 98, as depicted in FIG. 40. Referring to FIG. 41, wall jack 98 may support an eight position female jack 86 such as an RJ style jack.

In another embodiment of the invention, furniture consolidation panel 94 may be coupled to each individual work station component via a patch cord 100. Patch cord 100 may include a conventional RJ style male connector on each end, such as an RJ45 connector. In this embodiment of the invention, patch cord 100 are installed from the furniture consolidation panel 94 to each work station. Patch cord 100 may include a slip off cover designed to facilitate installation within the furniture raceway.

In the event that it is necessary to make moves, addition or changes to the arrangement of the work stations, station cables 80 are disconnected from the work stations, removed and coiled in the ceiling. The work stations are taken down and moved and reassembled. Existing composite cables 96 or station cables 80 can be reinstalled if they are of sufficient length.

If the existing pre-terminated cables are not sufficiently long at least two options can be exercised. A new pre-terminated cable can be installed from the nearest technology room 84 to the new work area, or an extension panel 102 may be placed for coupling to the existing cables and extension cables 104 may be coupled from the extension panel 102 to the new location. At the new furniture workstation location extension cables 104, or new cables, are dressed down to the access point 92 and pulled through the furniture raceways to furniture consolidation panel 94. Each cable end is connected to, and placed in, the furniture consolidation panel 94. Station patch cords 100 are then installed from furniture consolidation panel 94 to each workstation.

Referring to FIGS. 44-46, another aspect of the invention may be installed in a zoned implementation. In this embodiment of the invention, ceiling consolidation cabinets 106 are located and installed at ceiling level. In addition, voice cable 78 and data cable 76 are pulled from the consolidation cabinet 106, through the ceiling, and routed to appropriate access points designated to support each furniture workstation cluster. At the station location cable is coiled and hung in the ceiling close to where the access point 92 will be provided for later installation when access points 92 and furniture are in place. Similar to the embodiment discussed above, each composite cable 70 is labeled and coiled in the ceiling near the location of technology room 84. As discussed above, ladder racks, free-standing racks, and wall mount racks are installed as required. Composite cables 70 minimize labor involved in pulling, separation and dressing of cables. Each composite cable 70 is dressed to its connection point and plugged in in the technology room 84. The process continues in the technology room 84, as discussed above, until all voice cables 78 are connected. The process is then repeated for each data cable 76. In technology room 84, composite cable connectors are connected to jacks, and placed in the back of the patch panel until all data cables 76 are connected.

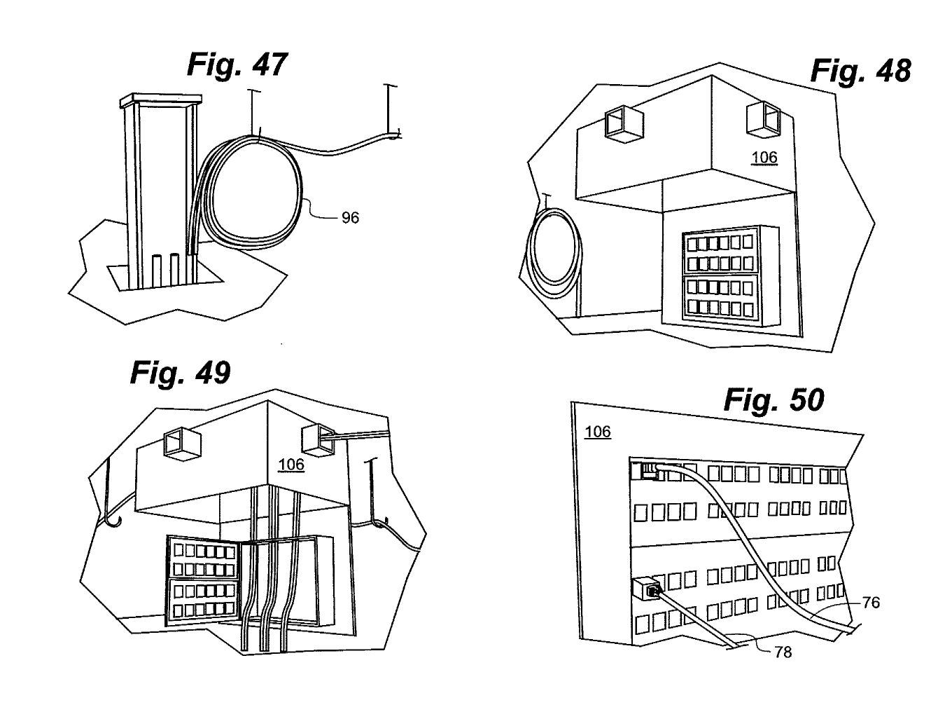

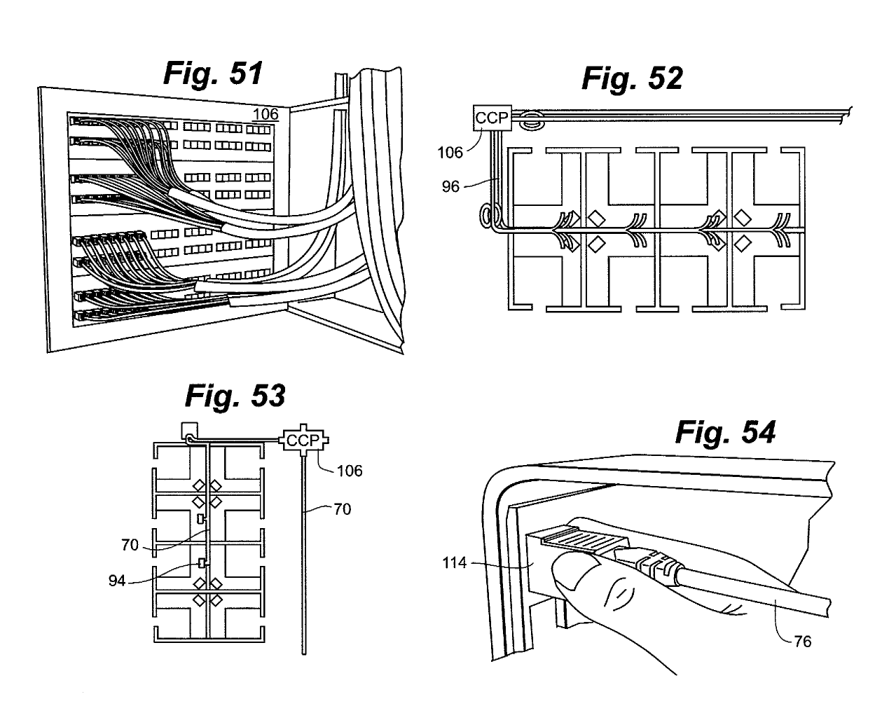

Once technology room 84 is completed, connections can be made at consolidation cabinets 106. Voice cable 78 and data cables 76 of composite cables 70 are separated from one another, dressed into consolidation cabinet 106 and placed in sequential order. Composite cable connectors 108 are secured in consolidation cabinets 106 until all voice cables 78 and data cables 76 are in place as depicted in FIGS. 48-51. Referring to FIG. 47, excess cable may be coiled in the ceiling near the ceiling consolidation cabinet 106 and at the station end near access points 92.

After ceiling grids, ceiling tile, and carpet is installed, and furniture power poles and access points 92 are located, the completion of station cabling connections at the workstations can begin.

The first option in accordance with the present invention is depicted in FIG. 52. Here, composite furniture cable 96 extends from ceiling located consolidation cabinet 106 to each workstation, composite furniture cable 96 includes data cables 76 and/or voice cable 78 in lengths staggered, for example every eight feet, or another distance, based on the size of the work spaces being installed. In this embodiment of the invention, the cable end male connector 72 is positioned and connected to each cable in a connector to each eight position jack located in a furniture face plate installed in the furniture partition.

In the second embodiment of the invention, depicted in FIG. 53, furniture consolidation panels 94 are located, for example, to support four work stations each. Each cable end from the ceiling consolidation cabinet 106 is connected and placed in the furniture consolidation panel 94.

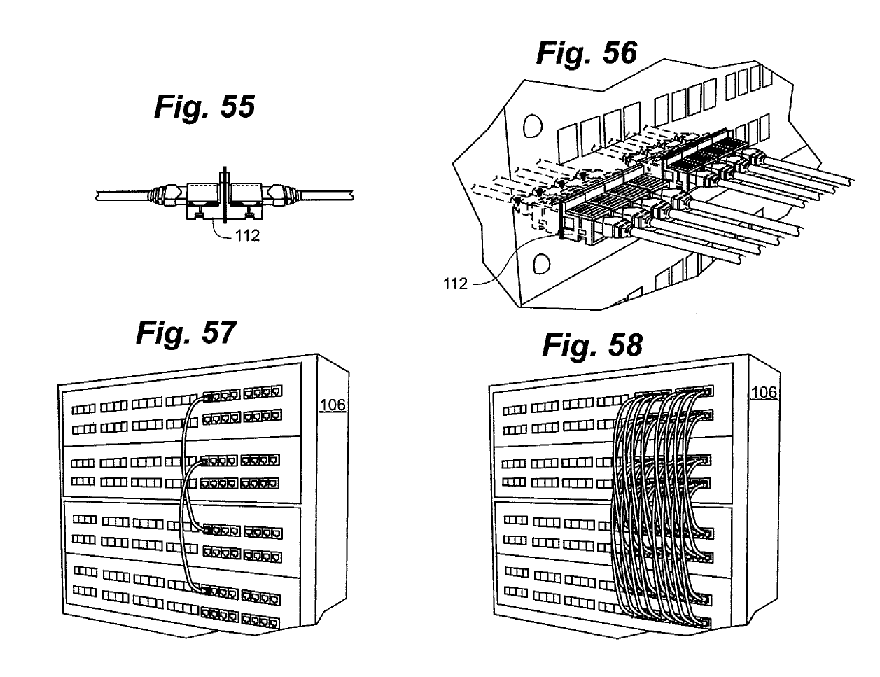

Station patch cords are then installed from furniture consolidation panels 94 to each workstation. This is depicted in FIG. 54. Referring to FIGS. 55-58, connections are then made with jumpers at the ceiling consolidation cabinet 106. Optionally, a space saving cabinet design can be implemented by using a dual-connector jack at the ceiling consolidation cabinet 106. This eliminates the need for jumpers at the ceiling consolidation cabinet 106.

The invention also includes the balancing of crosstalk between conductors within connectors 72, connector to connector coupler 112 or connector to RJ coupler 114. Balancing may be accomplished by configuration of conductor paths within the component or by the use of a printed circuit board within or coupled to the component. Balancing crosstalk facilitates the use of a preterminated solution by improving signal quality beyond that achievable by the use of, for example, conventional RJ connectors and couplers.

Compared to a traditional cable network installation, the inventive system's overall installation cost is competitive to install. Although there is an increase in the cost of material, the labor installation cost savings more than offset this increase.

Installation of the system of the present invention is simple, allowing many small companies and residential customers to install the system on their own.

The plug and play solution of the invention could save a company 50 to 70 percent or more on their moves, adds, and changes. Moves and changes are also more flexible, because customers can quickly and easily make their own changes without depending on the cable vendor's availability.

Once the decision is made to specify the solution of the present invention, the customer has a long term solution for the life of that installation.

The solution of the present invention provides certified contractors with a unique product, setting them apart from the competition and allowing them to create more enthusiasm and potentially more sales.

Reduced on-site labor requirements result in an easier installation process.

The consistent, high quality terminations result in less troubleshooting and corrections for on-site installation.

The solution of the present invention may also increase resale value. When companies vacate a space they are often required to pay a contractor to remove the abandoned cable. Because the solution of the present invention is easy to manage and easy to use, future tenants may wish to use the existing solution when they move into the space.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. A method of connecting computer and voice networks, comprising:
preterminating a plurality of voice or data cables with reusable connectors and combining them into composite preterminated cables;
positioning a consolidation panel at a location remote from a technology room and nearer to workstations than to the technology room;
installing in the consolidation panel a plurality of couplers adapted to receive the reusable connectors and
selecting a first composite preterminated cable from a selection of the composite preterminated cables having fixed preselected lengths such that the first preterminated cable has excess length beyond the distance needed to reach the consolidation panel from the technology room;
routing the first composite preterminated cable between the technology room and the consolidation panel;
coupling a plurality of first reusable connectors located at a first end of a first preterminated cable to a network component in the technology room;
coupling a plurality of second reusable connector located at a second end of the first preterminated cable to a coupling member at the consolidation panel; and
storing the excess length at a location between the technology room and the consolidation panel.

2. The method claimed in claim 1, further comprising:
selecting the coupling member to include a first receptacle for receiving the reusable connectors and a second receptacle also for receiving the reusable connectors;
selecting a second preterminated cable from the selection of preterminated cables having fixed preselected lengths;
coupling a third reusable connector located at a first end of the second preterminated cable to the coupling member at the consolidation panel; and
coupling a fourth reusable connector located at a second end of the second preterminated cable to a wall jack located proximate a desired workstation location.

3. The method claimed in claim 2, further comprising:
coupling a patch cord to the jack; and
coupling the patch cord to an item of network equipment at the workstation.

4. The method claimed in claim 1, further comprising:
selecting the coupling member to have a first receptacle for receiving the reusable connectors and a second receptacle for receiving an RJ style network connector;
installing the coupling member at the consolidation panel;
coupling a patch cord to the second receptacle; and
coupling the patch cord to an item of network equipment at the workstation.

5. The method claimed in claim 1, further comprising:
selecting a second composite preterminated cable from the selection of composite preterminated cables having fixed preselected lengths;
installing a second consolidation panel proximate one of the workstations and nearer the workstations than the first consolidation panel;
selecting the coupling member to have a first receptacle for receiving the reusable connector and a second receptacle for receiving a patch cord connector;
installing the coupling member at the second consolidation panel;
coupling a third reusable connector located at a first end of the second preterminated cable to the coupling member at the consolidation panel; and
coupling a fourth reusable connector located at a second end of the second preterminated cable to the second consolidation panel located proximate a desired workstation location.

6. The method claimed in claim 1, further comprising: locating the first consolidation panel proximate the workstation.

7. The method claimed in claim 1, further comprising: locating the first consolidation panel proximate a ceiling of the installation location in which the work station is located.

8. The method claimed in claim 1, further comprising:
in the event of a move, addition or change, decoupling the second reusable connector located at the second end of the first preterminated cable from the coupling member at the furniture consolidation panel;
placing an extension panel within reach of the second end of the first preterminated cable;
coupling the second reusable connector to the extension panel; and
coupling a third reusable connector located at a first end of a second reusable cable to the extension panel.

9. The method claimed in claim 1, further comprising:
selecting the reusable connector or the coupling member or both to include structure for balancing crosstalk between conductors.

10. The method claimed in claim 9, further comprising:
wherein the structure for balancing crosstalk comprises a printed circuit board.

11. The method claimed in claim 1, wherein preterminating the cable is performed in a manufacturing facility remote from an installation location.

12. A kit for connecting data and/or voice networks, comprising:
a first consolidation panel;
a selection of preterminated cables having fixed preselected lengths, each preterminated cable having reusable connectors affixed to ends thereof;
coupling members;
instructions for an installer including:
positioning a consolidation panel at a location remote from a technology room and nearer to workstations than to the technology room;
installing in the consolidation panel a plurality of couplers adapted to receive the reusable connectors;
selecting a first composite preterminated cable from a selection of the composite preterminated cables having fixed preselected lengths such that the first preterminated cable has excess length beyond the distance needed to reach the consolidation panel from the technology room;
routing the first composite preterminated cable between the technology room and the consolidation panel;
coupling a plurality of first reusable connectors located at a first end of a first preterminated cable to a network component in the technology room;
and
coupling a plurality of second reusable connector located at a second end of the first preterminated cable to a coupling member at the consolidation panel; and
storing the excess length somewhere between the technology room and the consolidation panel.

13. The kit claimed in claim 12, the instructions further comprising:
selecting the coupling member to include a first receptacle for receiving the reusable connectors and a second receptacle also for receiving the reusable connectors;
selecting a second preterminated cable from the selection of preterminated cables having fixed preselected lengths;
coupling a third reusable connector located at a first end of the second preterminated cable to the coupling member at the consolidation panel; and
coupling a fourth reusable connector located at a second end of the second preterminated cable to a wall jack located proximate a desired workstation location.

14. The kit claimed in claim 13, the instructions further comprising:
coupling a patch cord to the jack; and
coupling the patch cord to an item of network equipment at the workstation.

15. The kit claimed in claim 12, the instructions further comprising:
selecting the coupling member to have a first receptacle for receiving the reusable connectors and a second receptacle for receiving an RJ style network connector;
installing the coupling member at the consolidation panel;
coupling a patch cord to the second receptacle; and
coupling the patch cord to an item of network equipment at the workstation.

16. The kit claimed in claim 12, the instructions further comprising:
selecting a second composite preterminated cable from the selection of composite preterminated cables having fixed preselected lengths;
installing a second consolidation panel proximate one of the workstations and nearer the workstations than the first consolidation panel;
selecting the coupling member to have a first receptacle for receiving the reusable connector and a second receptacle for receiving a patch cord connector;
installing the coupling member at the second consolidation panel;
coupling a third reusable connector located at a first end of the second preterminated cable to the coupling member at the consolidation panel; and
coupling a fourth reusable connector located at a second end of the second preterminated cable to the second consolidation panel located proximate a desired workstation location.

17. The kit claimed in claim 12, the instructions further comprising: locating the first consolidation panel proximate the workstation.

18. The kit claimed in claim 12, the instructions further comprising: locating the first consolidation panel proximate a ceiling of the installation location in which the work station is located.

19. The kit claimed in claim 12, the instructions further comprising:
in the event of a move, addition or change, decoupling the second reusable connector located at the second end of the first preterminated cable from the coupling member at the furniture consolidation panel;
placing an extension panel within reach of the second end of the first preterminated cable;
coupling the second reusable connector to the extension panel; and
coupling a third reusable connector located at a first end of a second reusable cable to the extension panel.

20. The kit claimed in claim 12, wherein:
wherein at least some of the reusable connectors or the coupling members or both to include structure for balancing crosstalk between conductors.

21. The kit claimed in claim 20, wherein:
the structure for balancing crosstalk comprises a printed circuit board.

22. A method of connecting computer and voice networks, comprising:
preterminating a plurality of voice or data cables with reusable connectors and combining them into composite preterminated cables;
positioning a workstation at a location remote from a technology room;
installing in a panel in the technology room a plurality of couplers adapted to receive the reusable connectors and
selecting a first composite preterminated cable from a selection of the composite preterminated cables having fixed preselected lengths such that the first preterminated cable has excess length beyond the distance needed to reach a proximity of the workstation from the technology room;
routing the first preterminated cable between the technology room and the proximity of the workstation;
coupling a first reusable connector located at a first end of a first of the preterminated cables to the coupler in the panel in the technology room;
operably coupling the coupler in the panel to a first network component in the technology room;
coupling a second reusable connector located at a second end of the first preterminated cable to a second network component proximate the workstation; and
storing the excess cable length at a location between the technology room and the second network component.

23. The method as claimed in claim 22, further comprising:
selecting the second network component at the workstation to comprise a computer or a telephone

24. The method as claimed in claim 22, further comprising:
selecting the second network component proximate the workstation to comprise a first consolidation panel.

25. The method as claimed in claim 22, further comprising:
installing in the first consolidation panel a plurality of couplers adapted to receive the reusable connectors;
coupling a plurality of second reusable connectors located at a second end of the first preterminated cable to a coupling member at the consolidation panel;
operably coupling a second preterminated cable between one of the plurality of couplers and a network component at the workstation.

26. The method as claimed in claim 25, further comprising:
coupling the second preterminated cable to a wall jack at the workstation; and
coupling a patchcord between the wall jack and a third network component at the workstation.

27. The method as claimed in claim 25, further comprising:
installing a second consolidation panel nearer to the workstation than the first consolidation panel;
installing in the second consolidation panel a second plurality of couplers adapted to receive the reusable connectors;
operably coupling a third preterminated cable between the couplers in the second consolidation panel and a third network component located at the workstation.
